(19) United States
(12) Patent Application Publication
(10) Pub. No.: US 2016/0178977 A1
(43) Pub. Date: Jun. 23, 2016

(54) ARRAY SUBSTRATE AND LIQUID CRYSTAL DISPLAY PANEL

(71) Applicant: Shenzhen China Star Optoelectronics Technology Co., Ltd., Guangdong (CN)

(72) Inventors: Jiali Jiang, Guangdong (CN); Minghung Shih, Guangdong (CN)

(21) Appl. No.: 14/416,119

(22) PCT Filed: Nov. 20, 2014
(86) PCT No.: PCT/CN2014/091724

§ 371 Date: Aug. 31, 2015

(30) Foreign Application Priority Data
Nov. 18, 2014 (CN) 201410657707.X

(51) Int. Cl. G02F 1/1343; G02F 1/1335

(52) U.S. Cl. CPC G02F 1/134363; G02F 1/133514

(57) ABSTRACT

An array substrate and a panel is provided. The array substrate comprises: a first electrode and a second electrode, wherein one end of a first trunk portion is connected to a first common portion; the other end of the first trunk portion is connected to a first bending portion; an included angle of the extending direction of the first trunk portion and the extending direction of the first bending portion is between 40-50 degrees; one end of a second trunk portion is connected to a second common portion; the other end of the second trunk portion is connected to a second bending portion; and an included angle of the extending direction of the second trunk portion and the extending direction of the second bending portion is between 40-50 degrees.

### FIELD OF THE INVENTION

The present invention relates to a technical field of liquid crystal displays, and more particularly to an array substrate and a liquid crystal display panel.

### BACKGROUND OF THE INVENTION

An IPS (in-plane switching) panel combines common electrodes and pixel electrodes into one substrate, so that it is different from a panel which has the two kinds of electrodes disposed on different substrates respectively. An IPS panel can optimize the arrangement of liquid crystal molecules becoming a horizontal arrangement. When bearing an external force, the structure of the liquid crystal molecules can provide better solidity and stability, so that they can avoid a phenomenon of picture distortion or color variation, and the displaying effect is improved.

However, when a traditional IPS panel is in operation, inevitably there are dark-line regions on it, and more particularly larger dark-line regions are on the edges of the panel, so that the penetration rate and display effect of the panel are influenced.

Hence, it is necessary to provide an array substrate and a liquid crystal display panel which solves the problems existing in the conventional technologies.

### SUMMARY OF THE INVENTION

One of the objects of the present invention is to provide an array substrate and a liquid crystal display panel, so that a technical problem of dark-line regions existing in the traditional electrode design of an IPS panel when in operation is solved, and the display effect is improved.

For solving the above-mentioned technological problems, the present invention provides a plurality of technical solutions which are as follows:

One of the embodiment of the present invention provides an array substrate, which comprises:

a first electrode comprising a first common portion and a plurality of first main body portions, wherein one end of the first main body portion is connected to the first common portion; and the other end of the first main body portion is provided with a first bending portion; and

a second electrode comprising a second common portion and a plurality of second main body portions, wherein one end of the second main body portion is connected to the second common portion; the other end of the second main body portion is provided with a second bending portion; and the main body portions are disposed to interlace and space with the second main body portions;

wherein the first main body portion comprises a first trunk portion and the first bending portion; wherein one end of the first trunk portion is connected to the first common portion; the other end of the first trunk portion is connected to the first bending portion; and a first included angle of the extending direction of the first trunk portion and the extending direction of the first bending portion is between 40-50 degrees;

the second main body portion comprises a second trunk portion and the second bending portion; one end of the second trunk portion is connected to the second common portion; the other end of the second trunk portion is connected to the second bending portion; and a second included angle of the extending direction of the second trunk portion and the extending direction of the second bending portion is between 40-50 degrees;

a first distance which is between the first bending portion and the second common portion is from 3 to 10 micrometers; and

a second distance which is between the second bending portion and the first common portion is from 3 to 10 micrometers.

In the array substrate according to the present invention, the first included angle and the second included angle are both 45 degrees.

In the array substrate according to the present invention, the first distance is 5 micrometers.

In the array substrate according to the present invention, the second distance is 5 micrometers.

In the array substrate according to the present invention, the length of the first bending portion is from 2 to 5 micrometers.

In the array substrate according to the present invention, the length of the second bending portion is from 2 to 5 micrometers.

In the array substrate according to the present invention, the first trunk portion comprises a first branch portion and a second branch portion, wherein one end of the first branch portion is connected to one end of the second branch portion; the other end of the first branch portion is connected to the first common portion; the other end of the second branch portion is connected to the first bending portion; and an included angle of the extending direction of the first bending portion and the extending direction of the second branch portion is between 40-50 degrees; and

the second trunk portion comprises a third branch portion and a fourth branch portion, wherein one end of the third branch portion is connected to one end of the fourth branch portion; the other end of the third branch portion is connected to the second common portion; the other end of the fourth branch portion is connected to the second bending portion; and an included angle of the extending direction of the second bending portion and the extending direction of the fourth branch portion is between 40-50 degrees.

One of the embodiment of the present invention provides an array substrate, which comprises:

a first electrode comprising a first common portion and a plurality of first main body portions, wherein one end of the first main body portion is connected to the first common portion; and the other end of the first main body portion is provided with a first bending portion; and

a second electrode comprising a second common portion and a plurality of second main body portions, wherein one end of the second main body portion is connected to the second common portion; the other end of the second main body portion is provided with a second bending portion; and the main body portions are disposed to interlace and space with the second main body portions;

wherein the first main body portion comprises a first trunk portion and the first bending portion; wherein one end of the first trunk portion is connected to the first common portion; the other end of the first trunk portion is connected to the first bending portion; and a first included angle of the extending direction of the first trunk portion and the extending direction of the first bending portion is between 40-50 degrees; and

the second main body portion comprises a second trunk portion and the second bending portion; one end of the second trunk portion is connected to the second common portion; the other end of the second trunk portion is connected to the second bending portion; and a second included angle of the extending direction of the second trunk portion and the extending direction of the second bending portion is between 40-50 degrees.

In the array substrate according to the present invention, the first included angle and the second included angle are both 45 degrees.

In the array substrate according to the present invention, a first distance which is between the first bending portion and the second common portion is from 3 to 10 micrometers.

In the array substrate according to the present invention, the first distance is 5 micrometers.

In the array substrate according to the present invention, a second distance which is between the second bending portion and the first common portion is from 3 to 10 micrometers.

In the array substrate according to the present invention, the second distance is 5 micrometers.

In the array substrate according to the present invention, the length of the first bending portion is from 2 to 5 micrometers.

In the array substrate according to the present invention, the length of the second bending portion is from 2 to 5 micrometers.

In the array substrate according to the present invention, the first trunk portion comprises a first branch portion and a second branch portion, wherein one end of the first branch portion is connected to one end of the second branch portion; the other end of the first branch portion is connected to the first common portion; the other end of the second branch portion is connected to the first bending portion; and an included angle of the extending direction of the first bending portion and the extending direction of the second branch portion is between 40-50 degrees; and

the second trunk portion comprises a third branch portion and a fourth branch portion, wherein one end of the third branch portion is connected to one end of the fourth branch portion; the other end of the third branch portion is connected to the second common portion; the other end of the fourth branch portion is connected to the second bending portion; and an included angle of the extending direction of the second bending portion and the extending direction of the fourth branch portion is between 40-50 degrees.

One of the embodiment of the present invention further provides a liquid crystal display panel, which comprises:

a color filter substrate;

an array substrate; and

a liquid crystal layer disposed between the color filter substrate and the array substrate;

wherein the array substrate comprises:

a first electrode comprising a first common portion and a plurality of first main body portions, wherein one end of the first main body portion is connected to the first common portion; and the other end of the first main body portion is provided with a first bending portion; and

a second electrode comprising a second common portion and a plurality of second main body portions, wherein one end of the second main body portion is connected to the second common portion; the other end of the second main body portion is provided with a second bending portion; and the main body portions are disposed to interlace and space with the second main body portions;

wherein the first main body portion comprises a first trunk portion and the first bending portion; wherein one end of the first trunk portion is connected to the first common portion; the other end of the first trunk portion is connected to the first bending portion; and a first included angle of the extending direction of the first trunk portion and the extending direction of the first bending portion is between 40-50 degrees; and

the second main body portion comprises a second trunk portion and the second bending portion; one end of the second trunk portion is connected to the second common portion; the other end of the second trunk portion is connected to the second bending portion; and a second included angle of the extending direction of the second trunk portion and the extending direction of the second bending portion is between 40-50 degrees.

By improving the electrodes structure of the traditional IPS panel, the array substrate and the liquid crystal display panel according to the present invention can solve the problem of dark-line regions existing in the display panel when in operation, and the display effect is improved.

The above-mention contents of the present invention can be best understood by referring to the following detailed description of the preferred embodiments and the accompanying drawings.

### DESCRIPTION OF THE DRAWINGS

FIG. 1 is a structural schematic view of electrodes of an IPS panel according to a first embodiment of the present invention;

FIG. 2 is a structural schematic view of electrodes of an IPS panel according to a second embodiment of the present invention;

FIG. 3 is an enlarged structural schematic view of a first electrode according to a second embodiment of the present invention; and

FIG. 4 is an enlarged structural schematic view of a second electrode according to a second embodiment of the present invention.

### DETAILED DESCRIPTION OF THE PREFERRED EMBODIMENTS

The foregoing objects, features, and advantages adopted by the present invention can be best understood by referring to the following detailed description of the preferred embodiments and the accompanying drawings. Furthermore, the directional terms described in the present invention, such as upper, lower, front, rear, left, right, inner, outer, side, etc., are only directions with reference to the accompanying drawings, so that the used directional terms are used to describe and understand the present invention, but the present invention is not limited thereto.

In the drawings, units with similar structures use the same numerals.

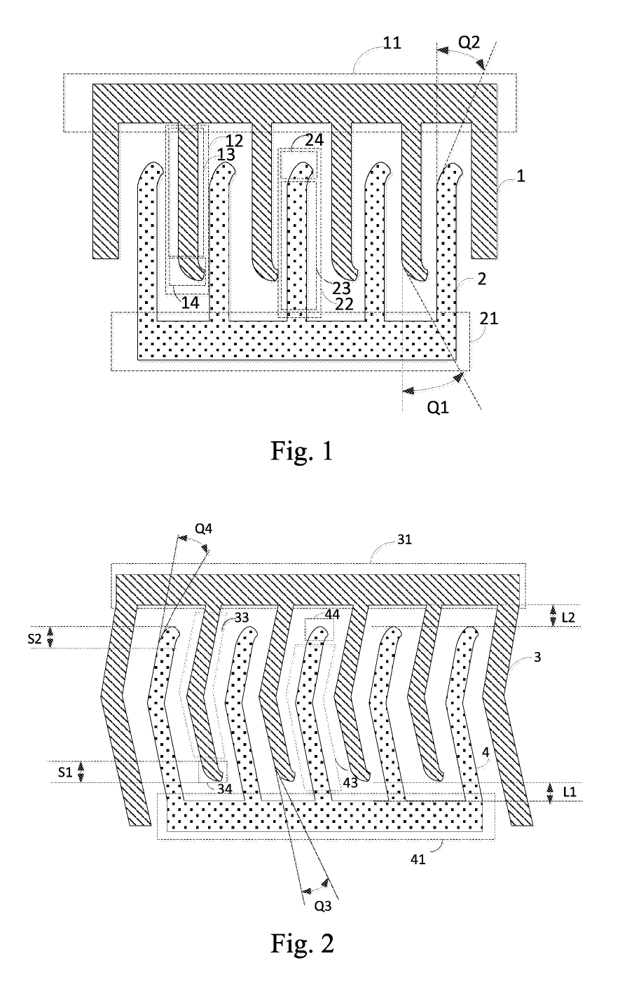

Refer now to FIG. 1, which is a structural schematic view of electrodes of an IPS panel according to a first embodiment of the present invention.

A pixel area of an array substrate according to the present invention is shown in FIG. 1. The array substrate comprises a first electrode and a second electrode, wherein the first electrode 1 is a pixel electrode or a common electrode, and the second electrode 2 is a common electrode or a pixel electrode. The first electrode 1 comprises a first common portion 11 and a plurality of first main body portions 12, wherein one end of the first main body portion 12 is connected to the first common portion 11, and the other end of the first main body portion 12 is provided with a first bending portion 14.

The second electrode 2 comprises a second common portion 21 and a plurality of second main body portions 22, wherein one end of the second main body portion 22 is connected to the second common portion 21, and the other end of the second main body portion 22 is provided with a second bending portion 24. Moreover, the first main body portions 12 are disposed to interlace and space with the second main body portions 22.

The first main body portion 12 comprises a first trunk portion 13 and the first bending portion 14, wherein one end of the first trunk portion 13 is connected to the first common portion 11; the other end of the first trunk portion 13 is connected to the first bending portion 14; and a first included angle Q1 of the extending direction of the first trunk portion 13 and the extending direction of the first bending portion 14 is between 40-50 degrees.

The second main body portion 22 comprises a second trunk portion 23 and the second bending portion 24, wherein one end of the second trunk portion 23 is connected to the second common portion 21; the other end of the second trunk portion 23 is connected to the second bending portion 24; and a second included angle Q2 of the extending direction of the second trunk portion 23 and the extending direction of the second bending portion 24 is between 40-50 degrees.

When the array substrate is in operation, a horizontal electric field is formed between the first electrode and the second electrode, so that liquid crystal molecules disposed on the substrate are twisted under the action of the horizontal electric field. During operation, data lines disposed on the substrate also produce a side electric field, so that the twisting angle of the liquid crystal molecules which are disposed on the edges of the substrate are influenced. By adding the bending portion, a compensating electric field is formed between the bending portion of one electrode and the common portion of the other electrode (such as between the first bending portion and the second common portion). By the included angle between the bending portion and the trunk portion of the same electrode being disposed in the above-mentioned range, the intensity of the produced compensating electric field is stronger and more stable than that in the other angles, so that the side electric field produced by the data lines which influences the liquid crystal molecules is effectively avoided, and the liquid crystal molecules are arranged in a better order, so as to avoid the dark-line region being formed, and the display effect of the panel is improved.

By improving the electrode structure of a traditional IPS panel, the array substrate of the present invention solves a problem of dark-line regions when the display panel is in operation, so as to increase the display effect thereof.

Refer now to FIG. 2, which is a structural schematic view of electrodes of an IPS panel according to a second embodiment of the present invention.

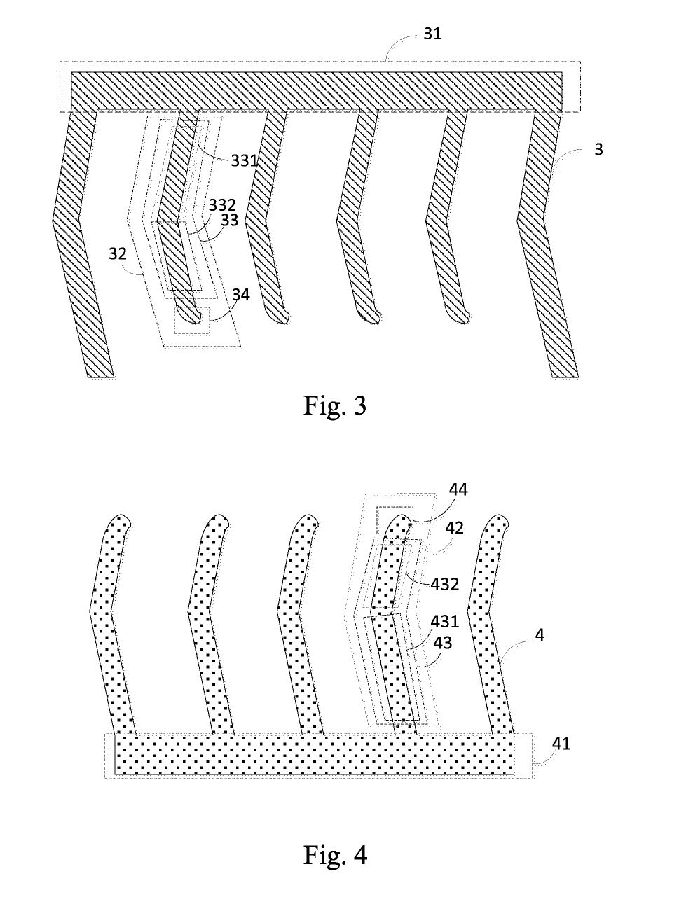

A pixel area of an array substrate according to the present invention is shown in FIG. 2. The array substrate comprises a first electrode and a second electrode, wherein the first electrode 3 is a pixel electrode or a common electrode, and the second electrode 4 is a common electrode or a pixel electrode. Refer now to FIG. 3, which is an enlarged structural schematic view of a first electrode according to a second embodiment of the present invention.

The first electrode 3 comprises a first common portion 31 and a plurality of first main body portions 32, wherein one end of the first main body portion 32 is connected to the first common portion 31, and the other end of the first main body portion 32 is provided with a first bending portion 34.

Refer now to FIG. 4, which is an enlarged structural schematic view of a second electrode according to a second embodiment of the present invention. The second electrode 4 comprises a second common portion 41 and a plurality of second main body portions 42, wherein one end of the second main body portion 42 is connected to the second common portion 41, and the other end of the second main body portion 42 is provided with a second bending portion 44. Moreover, the first main body portions 32 are disposed to interlace and space with the second main body portions 42. Preferably, a distance between the first main body portion 32 and the second main body portion 42 is the same, so as to form an electric field with an equivalent intensity.

The first main body portion 32 comprises a first trunk portion 33 and the first bending portion 34, wherein one end of the first trunk portion 33 is connected to the first common portion 31; and the other end of the first trunk portion 33 is connected to the first bending portion 34.

The second main body portion 42 comprises a second trunk portion 43 and the second bending portion 44, wherein one end of the second trunk portion 43 is connected to the second common portion 41; and the other end of the second trunk portion 43 is connected to the second bending portion 44.

The first trunk portions and the second trunk portions are disposed parallel to each other, so that a direction of the electric field can be more identical.

Preferably, the first electrode and the second electrode are obtained by a graphical operating of the same transparent conductive layer of the array substrate. The transparent conductive layer has a plurality of domains, and transparent electrodes in different domains of the transparent conductive layer have different extending directions, so that the liquid crystal molecules in the different domains have different inclining angles, so as to lower a crosstalk phenomenon of the liquid crystal display. For completing a multi-domain display, the first trunk portion 33 comprises a first branch portion 331 and a second branch portion 332, wherein one end of the first branch portion 331 is connected to one end of the second branch portion 332; the other end of the first branch portion 331 is connected to the first common portion 31; the other end of the second branch portion 332 is connected to the first bending portion 34; and an third included angle Q3 of the extending direction of the first bending portion 34 and the extending direction of the second branch portion 332 is between 40-50 degrees.

The second trunk portion 43 comprises a third branch portion 431 and a fourth branch portion 432, wherein one end of the third branch portion 431 is connected to one end of the fourth branch portion 432; the other end of the third branch portion 431 is connected to the second common portion 41; the other end of the fourth branch portion 432 is connected to the second bending portion 44; and a fourth included angle Q4 of the extending direction of the second bending portion 44 and the extending direction of the fourth branch portion 432 is between 40-50 degrees.

When the array substrate is in operation, a horizontal electric field is formed between the first electrode and the second electrode, so that liquid crystal molecules disposed on the substrate are twisted under the action of the horizontal electric field. In the operation, data lines disposed on the substrate also produce a side electric field, so that the twisting angle of the liquid crystal molecules which are disposed on the edges of the substrate are influenced. By adding the bending portion, a compensating electric field is formed between the bending portion of one electrode and the common portion of the other electrode (such as between the first bending portion and the second common portion). By the included angle between the bending portion and the trunk portion of the same electrode being disposed in the above-mentioned range, the intensity of the produced compensating electric field is stronger and more stable than that if it is disposed at other angles, so that the side electric field produced by the data lines which influences the liquid crystal molecules is effectively avoided, and the liquid crystal molecules are arranged in a better order, so as to avoid the dark-line region being formed, and the display effect of the panel is improved.

A first distance L1 which is between the first bending portion 34 and the second common portion 41 is able to be 3 to 10 micrometers; and preferably the first distance L1 is 5 micrometers.

A second distance L2 which is between the second bending portion 44 and the first common portion 31 is able to be 3 to 10 micrometers; and preferably the second distance L2 is 5 micrometers.

If the above-mentioned first distance or second distance is too small, a stable compensating electric field cannot be formed, and the twisting angle of the liquid crystal molecules will be too disordered to achieve an object of improving display effect. If the distance is too large, meaning the distance between the two electrodes is too far, the intensity of the compensating electric field is less, and a direction control ability for the liquid crystal molecules is also reduced, and the corresponding effect cannot be achieved.

The length S1 of the first bending portion 34 is able to be 2 to 5 micrometers; and preferably the length S1 is 3 micrometers.

The length S2 of the second bending portion 44 is also able to be 2 to 5 micrometers; and preferably the length S2 is 3 micrometers.

In limiting the production conditions, the length of the bending portion cannot be too short. If the above-mentioned length of the bending portion is too short, the bending portions having the same length cannot be ensured, and the intensity of the produced compensating electric field is uneven, so that the display effect is influenced. If the above-mentioned length of the bending portion is too long, the distance between the first electrode and the second electrode is too close, which is disadvantageous to forming a stable inclining direction, and the area of the dark-line region becomes greater.

By improving the electrode structure of a traditional IPS panel, the array substrate of the present invention solves a problem of dark-line regions when the display panel is in operation, so as to increase the display effect thereof.

The present invention further provides a liquid crystal display panel, which comprises a color filter substrate, an array substrate, and a liquid crystal layer, wherein the liquid crystal layer is disposed between the color filter substrate and the array substrate, and the array substrate comprises:

a first electrode comprising a first common portion and a plurality of first main body portions, wherein one end of the first main body portion is connected to the first common portion; and the other end of the first main body portion is provided with a first bending portion;

a second electrode comprising a second common portion and a plurality of second main body portions, wherein one end of the second main body portion is connected to the second common portion; the other end of the second main body portion is provided with a second bending portion; and the main body portions are disposed to interlace and space with the second main body portions;

wherein the first main body portion comprises a first trunk portion and the first bending portion; wherein one end of the first trunk portion is connected to the first common portion; the other end of the first trunk portion is connected to the first bending portion; and a first included angle of the extending direction of the first trunk portion and the extending direction of the first bending portion is between 40-50 degrees; and

the second main body portion comprises a second trunk portion and the second bending portion; one end of the second trunk portion is connected to the second common portion; the other end of the second trunk portion is connected to the second bending portion; and a second included angle of the extending direction of the second trunk portion and the extending direction of the second bending portion is between 40-50 degrees.

The liquid crystal display panel of the present invention can adopt any of the above-mentioned array substrates. Since they are described in the preceding paragraphs, they are not repeated again here.

By improving the electrode structure of a traditional IPS panel, the array substrate of the present invention solves a problem of dark-line regions when the display panel is in n operation, so as to increase the display effect thereof.

As described above, the present invention has been described with a preferred embodiment thereof and it is understood that many changes and modifications to the described embodiment can be carried out without departing from the scope and the spirit of the invention that is intended to be limited only by the appended claims.

1. An array substrate, comprising:
a first electrode comprising a first common portion and a plurality of first main body portions, wherein one end of the first main body portion is connected to the first common portion; and the other end of the first main body portion is provided with a first bending portion; and
a second electrode comprising a second common portion and a plurality of second main body portions, wherein one end of the second main body portion is connected to the second common portion; the other end of the second main body portion is provided with a second bending portion; and the main body portions are disposed to interlace and space with the second main body portions;
wherein the first main body portion comprises a first trunk portion and the first bending portion; wherein one end of the first trunk portion is connected to the first common portion; the other end of the first trunk portion is connected to the first bending portion; and a first included angle of the extending direction of the first trunk portion and the extending direction of the first bending portion is between 40-50 degrees;
the second main body portion comprises a second trunk portion and the second bending portion; one end of the second trunk portion is connected to the second common portion; the other end of the second trunk portion is connected to the second bending portion; and a second included angle of the extending direction of the second trunk portion and the extending direction of the second bending portion is between 40-50 degrees;
a first distance which is between the first bending portion and the second common portion is from 3 to 10 micrometers; and
a second distance which is between the second bending portion and the first common portion is from 3 to 10 micrometers.

2. The array substrate according to claim 1, wherein the first included angle and the second included angle are both 45 degrees.

3. The array substrate according to claim 1, wherein the first distance is 5 micrometers.

4. The array substrate according to claim 1, wherein the second distance is 5 micrometers.

5. The array substrate according to claim 1, wherein the length of the first bending portion is from 2 to 5 micrometers.

6. The array substrate according to claim 1, wherein the length of the second bending portion is from 2 to 5 micrometers.

7. The array substrate according to claim 1, wherein the first trunk portion comprises a first branch portion and a second branch portion, wherein one end of the first branch portion is connected to one end of the second branch portion; the other end of the first branch portion is connected to the first common portion; the other end of the second branch portion is connected to the first bending portion; and an included angle of the extending direction of the first bending portion and the extending direction of the second branch portion is between 40-50 degrees; and
the second trunk portion comprises a third branch portion and a fourth branch portion, wherein one end of the third branch portion is connected to one end of the fourth branch portion; the other end of the third branch portion is connected to the second common portion; the other end of the fourth branch portion is connected to the second bending portion; and an included angle of the extending direction of the second bending portion and the extending direction of the fourth branch portion is between 40-50 degrees.

8. An array substrate, comprising:
a first electrode comprising a first common portion and a plurality of first main body portions, wherein one end of the first main body portion is connected to the first common portion; and the other end of the first main body portion is provided with a first bending portion; and
a second electrode comprising a second common portion and a plurality of second main body portions, wherein one end of the second main body portion is connected to the second common portion; the other end of the second main body portion is provided with a second bending portion; and the main body portions are disposed to interlace and space with the second main body portions;
wherein the first main body portion comprises a first trunk portion and the first bending portion; wherein one end of the first trunk portion is connected to the first common portion; the other end of the first trunk portion is connected to the first bending portion; and a first included angle of the extending direction of the first trunk portion and the extending direction of the first bending portion is between 40-50 degrees; and
the second main body portion comprises a second trunk portion and the second bending portion; one end of the second trunk portion is connected to the second common portion; the other end of the second trunk portion is connected to the second bending portion; and a second included angle of the extending direction of the second trunk portion and the extending direction of the second bending portion is between 40-50 degrees.

9. The array substrate according to claim 8, wherein the first included angle and the second included angle are both 45 degrees.

10. The array substrate according to claim 8, wherein a first distance which is between the first bending portion and the second common portion is from 3 to 10 micrometers.

11. The array substrate according to claim 8, wherein the first distance is 5 micrometers.

12. The array substrate according to claim 8, wherein a second distance which is between the second bending portion and the first common portion is from 3 to 10 micrometers.

13. The array substrate according to claim 8, wherein the second distance is 5 micrometers.

14. The array substrate according to claim 8, wherein the length of the first bending portion is from 2 to 5 micrometers.

15. The array substrate according to claim 8, wherein the length of the second bending portion is from 2 to 5 micrometers.

16. The array substrate according to claim 8, wherein the first trunk portion comprises a first branch portion and a second branch portion, wherein one end of the first branch portion is connected to one end of the second branch portion; the other end of the first branch portion is connected to the first common portion; the other end of the second branch portion is connected to the first bending portion; and an included angle of the extending direction of the first bending portion and the extending direction of the second branch portion is between 40-50 degrees; and
the second trunk portion comprises a third branch portion and a fourth branch portion, wherein one end of the third branch portion is connected to one end of the fourth branch portion; the other end of the third branch portion is connected to the second common portion; the other end of the fourth branch portion is connected to the second bending portion; and an included angle of the extending direction of the second bending portion and the extending direction of the fourth branch portion is between 40-50 degrees.

17. A liquid crystal display panel, comprising:
a color filter substrate;
an array substrate; and
a liquid crystal layer disposed between the color filter substrate and the array substrate;
wherein the array substrate comprises:
a first electrode comprising a first common portion and a plurality of first main body portions, wherein one end of the first main body portion is connected to the first common portion; and the other end of the first main body portion is provided with a first bending portion; and
a second electrode comprising a second common portion and a plurality of second main body portions, wherein one end of the second main body portion is connected to the second common portion; the other end of the second main body portion is provided with a second bending portion; and the main body portions are disposed to interlace and space with the second main body portions;
wherein the first main body portion comprises a first trunk portion and the first bending portion; wherein one end of the first trunk portion is connected to the first common portion; the other end of the first trunk portion is connected to the first bending portion; and a first included angle of the extending direction of the first trunk portion and the extending direction of the first bending portion is between 40-50 degrees; and
the second main body portion comprises a second trunk portion and the second bending portion; one end of the second trunk portion is connected to the second common portion; the other end of the second trunk portion is connected to the second bending portion; and a second included angle of the extending direction of the second trunk portion and the extending direction of the second bending portion is between 40-50 degrees.
